(19) United States
(12) Patent Application Publication
(10) Pub. No.: US 2016/0305533 A1
(43) Pub. Date: Oct. 20, 2016

(54) ADAPTER KIT FOR COUPLING AN ENGINE TO A TRANSMISSION AND METHOD OF ASSEMBLING SAME

(71) Applicant: Brett Collins, Sarasota, FL (US)

(72) Inventor: Brett Collins, Sarasota, FL (US)

(21) Appl. No.: 15/132,111

(22) Filed: Apr. 18, 2016

Related U.S. Application Data
(60) Provisional application No. 62/149,266, filed on Apr. 17, 2015.

(51) Int. Cl. F16H 57/025

(52) U.S. Cl. CPC F16H 57/025

(57) ABSTRACT

An adaptor plate and associated components forming a kit that couples a bell housing associated with an internal combustion engine of one manufacturer to a manual transmission of different manufacturer.

### CROSS-REFERENCE TO RELATED APPLICATION

This patent application claims benefit under 35 U.S.C. §119 to U.S. Provisional Patent Application No. 62/149,266, filed Apr. 16, 2015, which is hereby incorporated by reference in its entirety as part of the present disclosure.

### FIELD OF THE INVENTION

The invention generally relates to automotive mechanics and more specifically to an adaptor plate and associated parts configured to couple an internal combustion engine produced by one manufacturer with a manual shift transmission produced by a different manufacturer that were not originally designed to function together.

### BACKGROUND OF THE INVENTION

A lack of manual shift transmissions are readily available for automotive repair and replacement after an existing transmission has exhausted its useful lifespan. It is difficult in many instances to acquire the parts needed to repair or replace a given transmission from a particular manufacturer. For example, Toyota has discontinued production of many six-speed manual transmissions. Existing Toyota five-speed manual transmissions are not capable of sustaining the torque transferred through the output of many engines supplied by Toyota after modification. As a result, there is a lack of aftermarket manual transmission solutions that can be coupled to a Toyota engine.

Additionally, a large market exists for custom building purposes where it is desired to replace an existing engine or transmission with a stronger engine or transmission of a higher capacity.

### SUMMARY OF THE INVENTION

The present invention solves the long standing problem of how to replace a manual shift transmission with one that the given engine was not originally designed to function with. In particular, the present invention provides a single adapter plate that can couple a series of similar engines of one manufacture with a series of manual shift transmissions of a different manufacture family.

Additionally, the present invention allows a consumer to fasten together engines from differing manufacturers using a similar series of bell housings to a series of manual shift transmissions from a different source of manufacture.

To achieve the foregoing, an embodiment of a product is described herein that allows a consumer to employ a kit to couple a manual shift transmission with a bell housing from an engine of a different manufacturer with which it was not originally designed to be coupled, resulting in an improved automobile.

In an embodiment, the invention includes irregularly-shaped disc with a particular transmission bolt hole pattern comprising a series of threaded drilled-through holes, threaded tapped holes, threaded counter-sunk holes and threaded recessed bolt holes which are machined into the adapter plate. The bolt hole pattern in the adapter plate is designed to align with an existing bell housing bolt hole pattern associated with an engine and align with an existing bolt hole pattern of a manual shift transmission so that the engine and the transmission can be bolted together. It also provides a configuration that does not compromise lubrication, avoids interference with transmission components, and by synergism with addition of a different engine flywheel, leaves a connection able to sustain high torque.

In an embodiment, the bolt hole patterns can include variations for compatibility with different engine/transmission combinations. In another embodiment, the product may include some, but not all the bolt hole pattern combinations.

Existing flywheels, custom-manufactured flywheels, flywheel adapters, clutch discs, and custom-manufactured clutch discs are well known in the art and are frequently used in the adaptation process along with the present invention to complete the engine-to-transmission conversion process. Said flywheels and clutch discs are not claimed per se in the present invention. Rather, the essence of the invention is the adapter plate in conjunction with such modified flywheels with the particularly disclosed bolt hole and recess pattern allowing the consumer to use the invention for multiple different transmission/engine bell housing combinations. The pattern presents a solution to the long standing problem of adapting specific engines and manual transmissions.

### BRIEF DESCRIPTION OF THE DRAWINGS

Having generally described the various embodiments of the invention, reference will now be made to the accompanying drawings, which are not necessarily drawn to scale, and wherein:

FIG. 1 is a perspective view of an embodiment of an engine mated to a transmission by use of the present invention;

FIG. 2 is a perspective view of a prior art transmission;

FIG. 3 is a partially exploded perspective view of a prior art transmission;

FIG. 4 is an exploded view of the embodiment of FIG. 1;

FIG. 5 is a perspective view of a bell housing from the engine side;

FIG. 6 is a perspective view of the bell housing of FIG. 5 from the transmission side;

FIG. 7 is a perspective view of an embodiment of an adapter plate of the present invention as viewed from the engine side;

FIG. 8 is a perspective view of the adapter plate of FIG. 7 as viewed from the transmission side;

FIG. 9 is a perspective view of the engine and associated surface that is mateable to the adaptor plate of FIG. 7;

FIG. 10 is a front perspective view of an embodiment of a flywheel of the present invention; and

FIG. 11 is a rear perspective view of the flywheel of FIG. 10.

### DETAIL DESCRIPTION OF EMBODIMENTS OF THE INVENTION

At the outset, it is noted that the term “couple” as used herein means to join or attach together, commonly by bolts and dowel pins, so as to result in the union of an engine to a transmission of differing manufacture. The result of such coupling along with use of an appropriate pilot bushing adaptor, bell housing, throw-out bearing, flywheel or clutch disc is the production of an operable motor that can be installed in and cause propelling motion of an automobile. The term “adapter plate” refers to a generally round disc that is a primary component of the present invention.

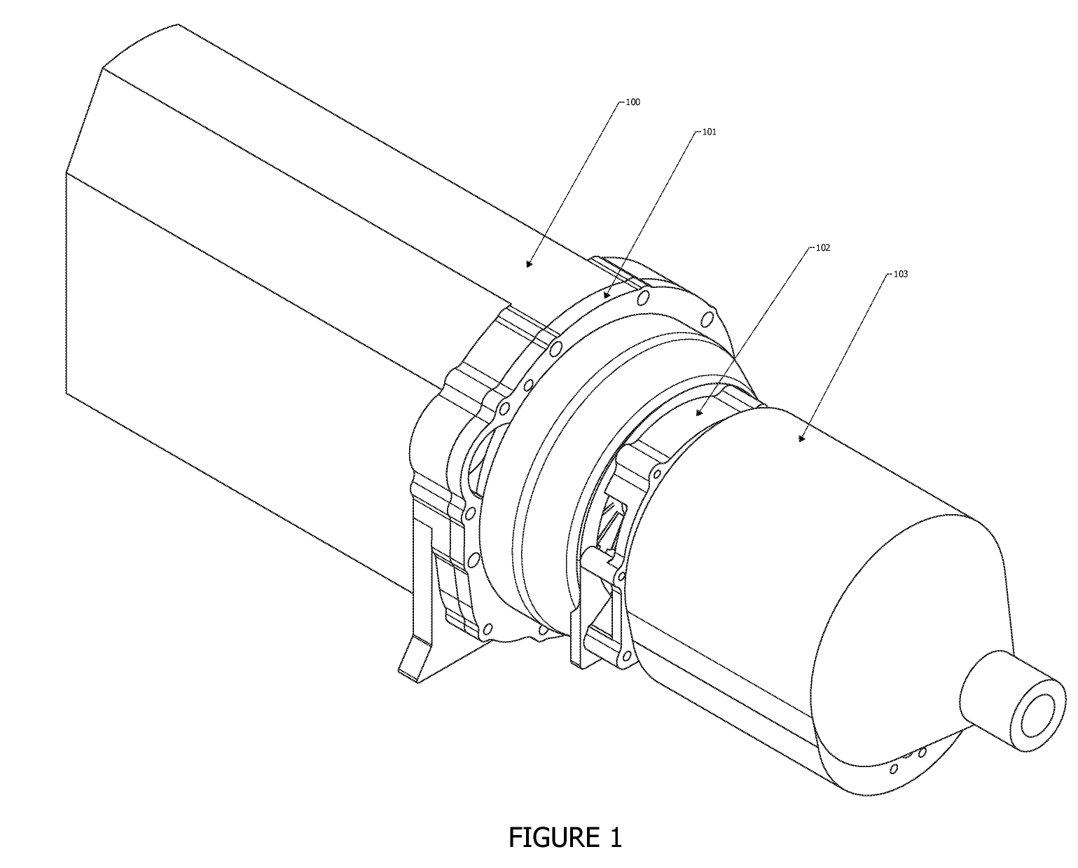

With reference now to the drawings, and in particular to FIGS. 1 through 11, an embodiment of an adaptor plate embodying the principles and concepts of the present invention, which is generally designated by the reference numeral 102 will be described.

FIG. 1 depicts an embodiment of the adaptor plate 102 that couples an existing internal combustion engine 100, via an existing bell housing 101, to an existing gearbox/transmission 103.

An engine and transmission are typically designed by a single manufacture to be assembled to each other for the production of a specific automobile. It is not intended by the manufacturer for a particular engine to function with a transmission of a different manufacturer. However, the adaptor plate 102 and the associated parts (described hereinafter) of the present disclosure can be used to couple eighty different bell housings associated with particular automotive engines commonly referred to as the Aisin AW Co., Ltd “A-series” automatic transmission bell housing coming from Aisin automatic transmission models A10, A20, A30, A40, A40D, A41, A42DL, A43, A43D, A43DL, A43DE, A44D, A44DL, A45DL, A46DE, A46DF, A47DE, A55, A130, A131L, A132L, A140E, A140L, A240L, A240E, A241E, A241H, A241L, A242L, A242E, A243L A244E, A245E, A246E, A340, A340H, A340E, A340E (30-40LE), A340F, A341, A341E, A341E (30-41LE), A341F, A343F, A350F, A440, A442, A540E, A541E, A350E, A750E, A750F, A760E, A760F, A760H, A761E, A860E, A960E, AA80E, AA80F, AA81E, AB60E, AB60F, AF33, AR5, MA5, AY6; bell housings can be used from Tremec models T-5, T-56, TR6060, TR6070; also General Motors automatic transmission bell housings from models 5L40, 5L40E, 5L50, 6L45, 6L50, 6L80, 6L90, 8L90, 8L95) can be coupled with manual shifting transmissions from Nissan models commonly referred to by one of ordinary skill in the art as 350Z, 370Z, 350Z HR, G35, G37, G50, VQ and VR 6-speed transmissions. Some with version #'s CD000, CD001, CD003, CD005, CD006, CD008, CD009, JK4OB and JK40C; the 350Z HR and 370Z HR transmissions with revision numbers JK40B, and JK40C; or to Nissan Models 300ZX or 300ZX Z32, either standard or turbo, by providing differing bolt pattern variations on a single adapter plate.

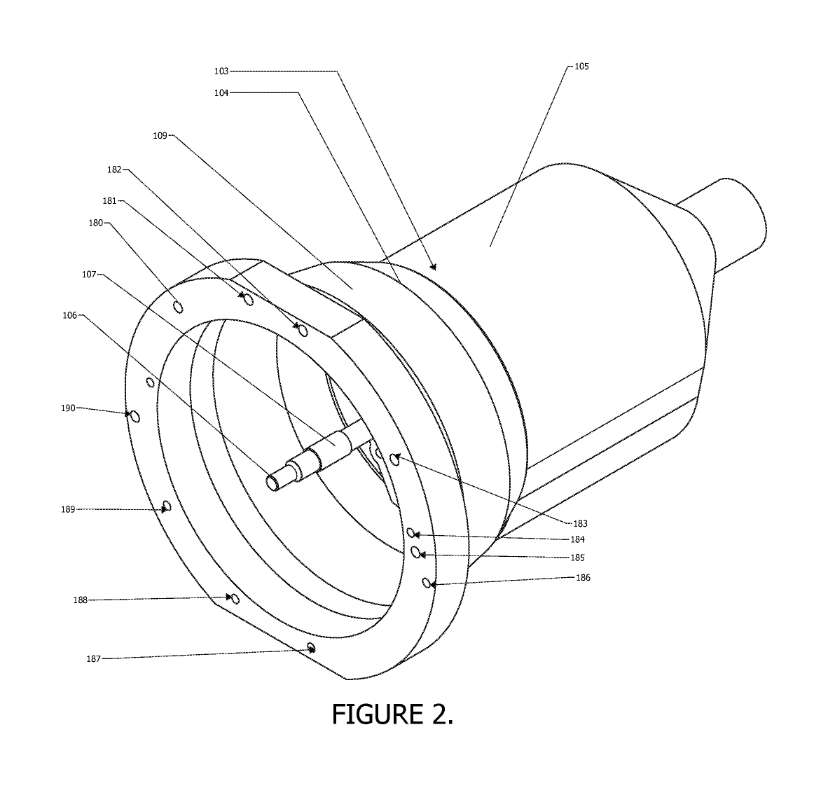

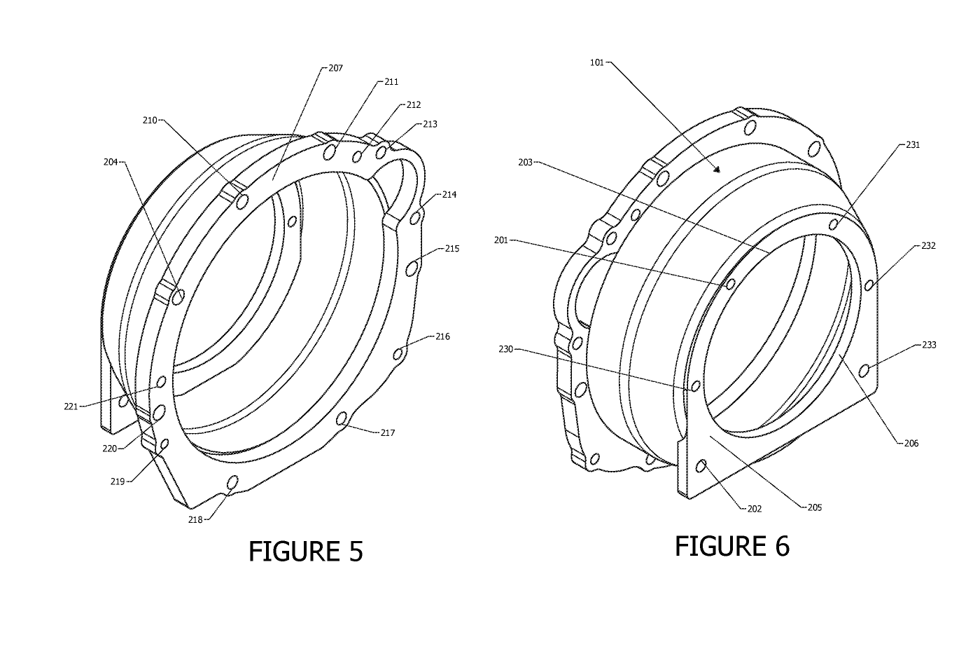

FIG. 2 depicts a perspective view of the transmission 103 that can be coupled together with the bell housing 101 associated with the engine 100. In an embodiment, the transmission may be for a Nissan 350Z which, through use of the present invention, may be mated with a Toyota series JZ engine. The transmission 103 has bolt holes 180 through 190 that are not compatible with the JZ engine bolt pattern 204, 210-221 (See FIG. 5).

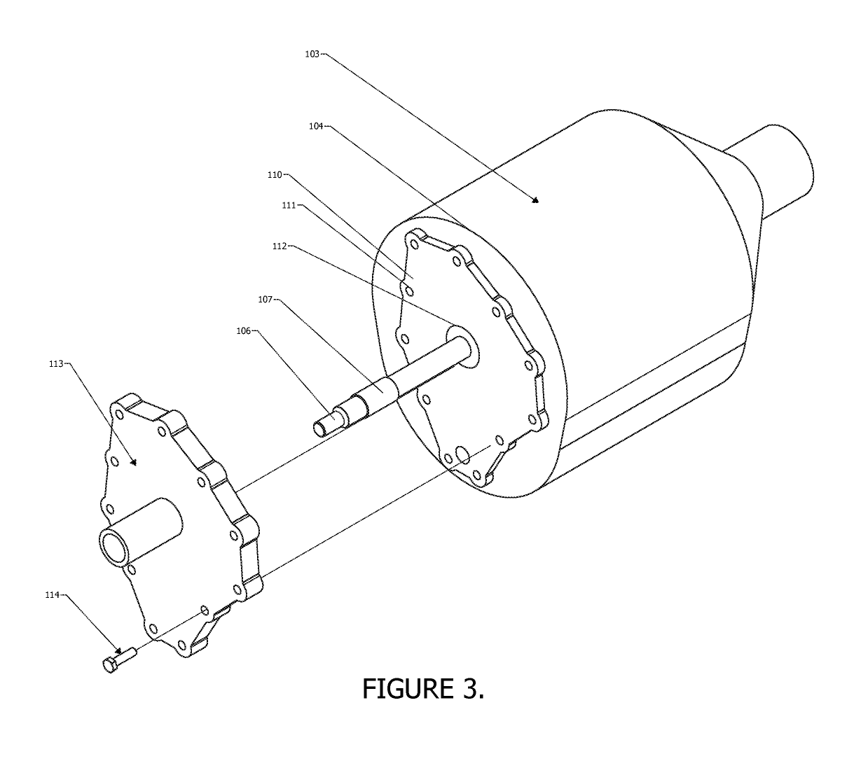

FIG. 3 illustrates a partially exploded view of the transmission 103 showing an input shaft cover 113 separated from the remainder of the transmission 103. As will be explained below, removal of the input shaft cover 113 is necessary to use the adaptor plate 102.

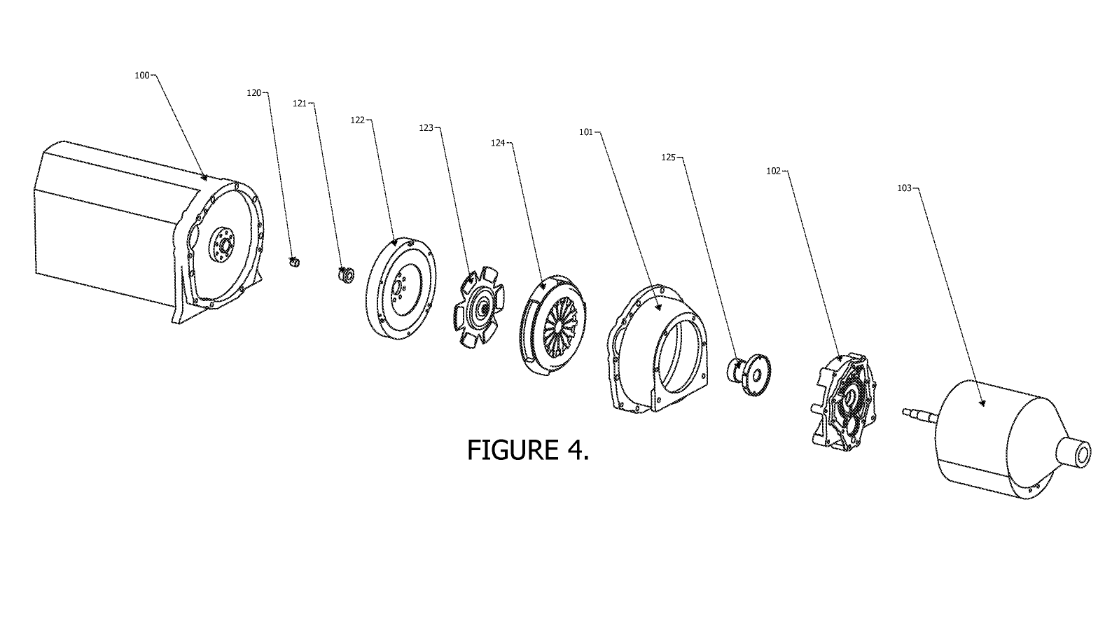

FIG. 4 is an assembly view of the engine 100, a pilot bushing 120, a pilot bushing adaptor 121, a flywheel 122, a clutch disk 123, a pressure plate 124, the bell housing 101, a throw-out bearing 125 (also known as a clutch release bearing, a concentric slave bearing or a hydraulic concentric slave cylinder), the adaptor plate 102 and the transmission 103. It is noted that the pilot bushing 120 may also be referred to as the pilot bearing and the transmission 103 may also be referred to as the gearbox. The pilot bushing adaptor 121 is designed to convert a large diameter of the crank boss 521 of the engine 100 of one manufacturer to a smaller diameter of the transmission 103 of another manufacturer.

In an embodiment, the adaptor plate 102 is included in a kit that can include the pilot bushing adapter 121, the flywheel 122, the bell housing 101, and the throw-out bearing 125.

FIGS. 5 and 6 depict a first and second perspective view of the bell housing 101. The bell housing 101 includes a mating surface 205 configured to abut with and connect to the adaptor plate 102 and a concentric machined hole 203. As shown in FIGS. 5 and 6, the bell housing 101 includes a plurality of holes 204 through 221 to mate with the engine 100 bolt pattern and a plurality of holes 201, 202, 230 through 233 to mount with an associated transmission housing (not a transmission not designed for direct assembly with the engine 100).

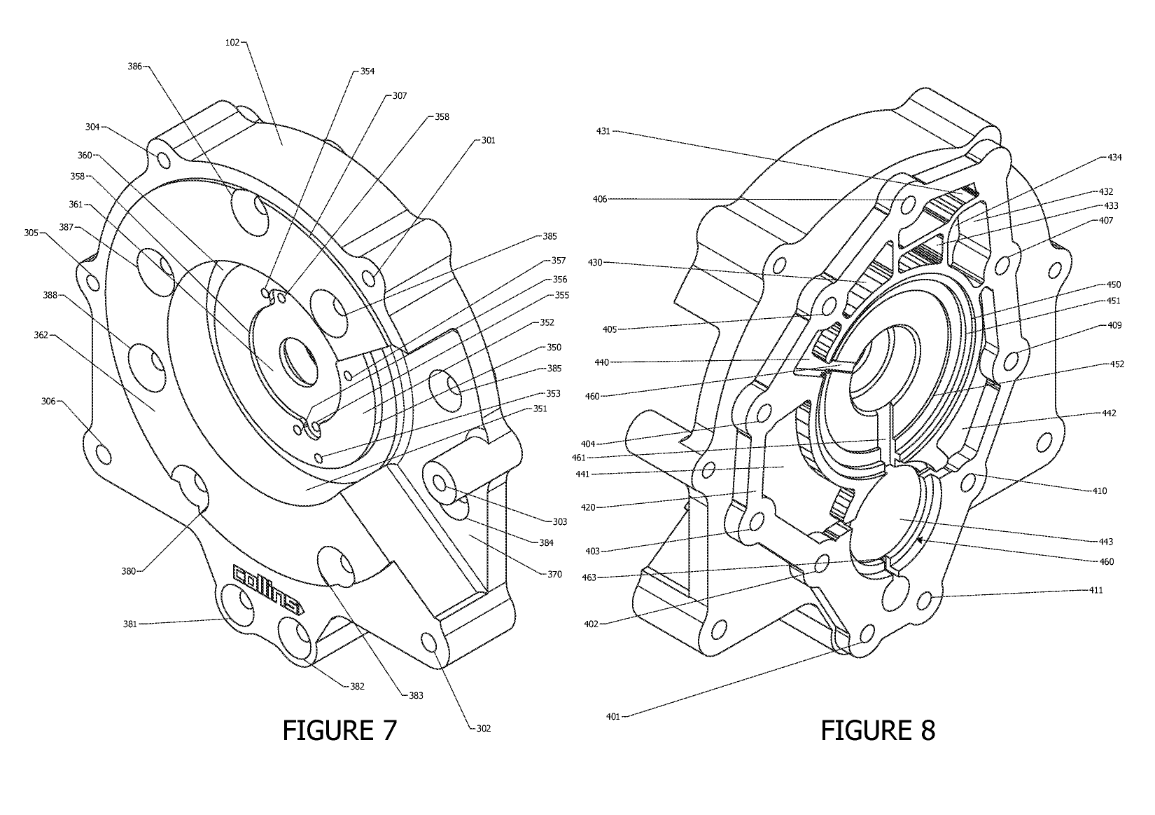

As shown in FIGS. 7 and 8, the adaptor plate 102 includes a plurality of bolt holes that are aligned with and allow for the coupling of the bell housing 101 of one manufacturer with the manual shift transmission housing 103 of another manufacturer of on the existing input shaft cover surface 110. To gain access to the surface 110 it is necessary to remove the input shaft cover 113 depicted in FIG. 3.

As shown in FIGS. 7 and 8, the adaptor plate 102 includes a bolt hole pattern configuration that includes five different series of bolt holes, Series 1, Series 2, Series 3, Series 4 and Series 5 that have different parameters. The Series 1 bolt hole pattern include six holes 380, 383, 385, 386, 387, 388 that are recessed and counter sunk. The Series 2 bolt hole pattern include four holes 381, 382, 384, 385 that are recessed and counter sunk like the Series 1 holes 380, 383, 385, 386, 387, 388 except the Series 2 holes 381, 382, 384, 385 have a different diameter and depth than those of Series 1. The Series 3 bolt hole pattern includes four holes 301, 303, 304, 305 that are tapped and threaded. The Series 4 bolt hole pattern includes two holes 302, 306 that are tapped threaded like the Series 3 holes 301, 303, 304, 305. However, the Series 4 holes 302, 306 have a different diameter than the Series 3 holes 301, 303, 304, 305. The Series 5 bolt hole pattern includes six holes 353, 354, 355, 356, 357, 358 that are tapped and threaded. However, these holes 353, 354, 355, 356, 357, 358 have a different diameter than the Series 3 holes 301, 303, 304, 305 and the Series 4 holes 302, 306.

In an embodiment, the adaptor plate 102 can be comprised of a metal or metal alloy, such as aluminum billet, steel billet, titanium billet, magnesium billet or steel plate. Additionally, the adapter plate 102 can be manufactured to have different thickness. In an embodiment, the adaptor plate 102 can have a thickness that is between about 3/8 inches to 4 inches (or millimeter equivalent).

As can be seen in an embodiment in FIG. 8, the channels/bored pockets 440-443 are designed to facilitate lubrication to the main input shaft bearing 112, internal parts of the transmission 103 and to provide clearance to allow the internal parts of the transmission 103 to move freely without contacting the adapter plate 102. These pockets 440-443 range in depth from about 0.125 inches to 0.5 inches depending on the depth of the mating parts. Pockets 430-434 are of a different depth ranging from about 0.5 inch to 1.5 inches to prevent interference transmission 103. The adaptor plate 102 further includes oil passageways 460-463 to allow for oil flow to the counter-shaft bearing.

The adaptor plate 102 further can include pockets 350, 351, 358 to hold concentric the slave cylinders. Pocket 370 is machined into the adaptor plate 102 to allow the hydraulic lines from concentric slave cylinder components 123 (FIG. 4) to be arranged under the bell housing surface 205.

To mate the components, one first removes, by cutting, shaving, or milling the bell housing 101 at the cut line 104 depicted in FIG. 2. The cut line 104 is approximately between about 4.5 and 8.0 inches from the front mounting hole 180. Once the bell housing 101 is removed in this manner, the input shaft cover 113 (FIG. 3) is removed, revealing surface 110 (FIG. 3) to which the adapter plate 102 is mated.

The adapter plate 102 joins the engine's bell housing 101 (FIG. 4) and transmission's main casing 103 (FIG. 3) by first being coupled to the bell housing mating face 205 (FIG. 6), and then being coupled to the mating face of the transmission casing 110 (FIG. 3) of a different manufacture by bolting means. It is through the removal of the existing bell housing material by grinding, cutting, or machining on the manual shift transmission 105 (FIG. 2) that one is then able to insert the adapter plate 102 (FIG. 4) on to surface 110 (FIG. 3) with sufficient room as to not interfere with the manual shift transmission 103 as shown in FIG. 4. This mating surface is the location of the bolt-hole pattern Series 1 and 1 as shown in (FIGS. 7 and 8) by which, bolting the manual shift transmission to the adapter plate 102 is achieved. The adapter plate 102 and the bell housing 101 are kept concentric by dowel pins holes, or a step 362 (FIG. 7) that is machined into the bell housing side of the adapter plate 102 (FIG. 7). Said step, or raised circular portion of the adapter plate 102, then recesses concentrically into the bell housing hole 203 (FIG. 6).

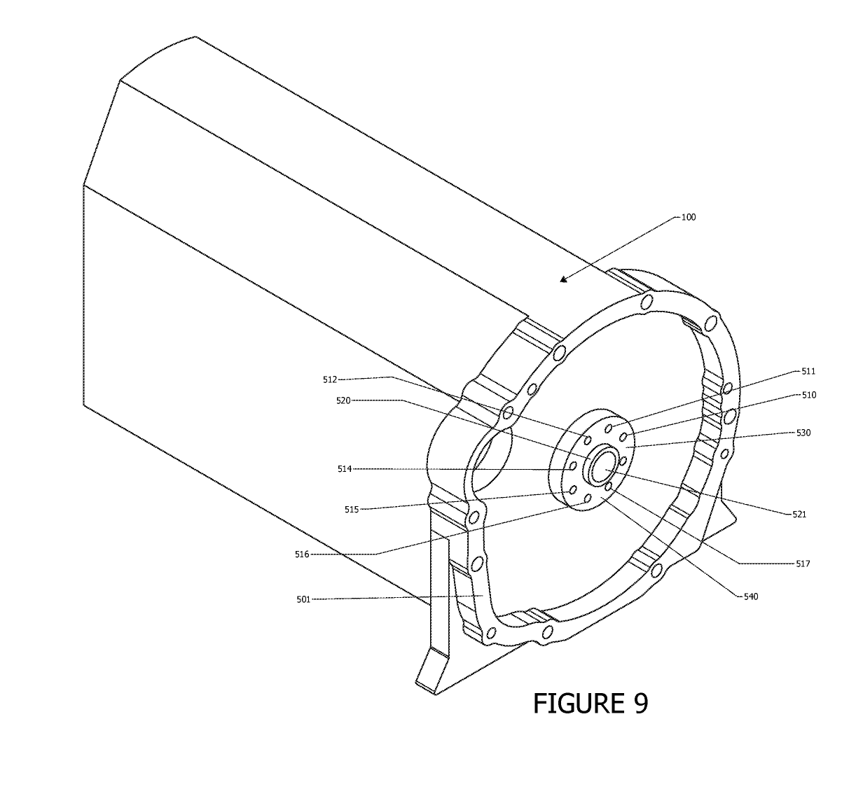

FIG. 9 illustrates the engine 100 and associated components that mate to the bell housing 101. The engine includes a plurality of holes 510 through 517 that are drilled and tapped to mate with the flywheel 122. As shown, the engine 100 includes a crank boss 520 with an inner pocket 521 in which the pilot bushing adapter 121 is pressed. It is noted that the outer diameter of pilot bushing adapter 121 closely matches that of the crank boss 520 to facilitate centering of the flywheel 122 on the crank 540. The pilot bearing adapter 121 has a depth at which it holds the pilot bushing 120 that is critical to the performance of the input shaft 106.

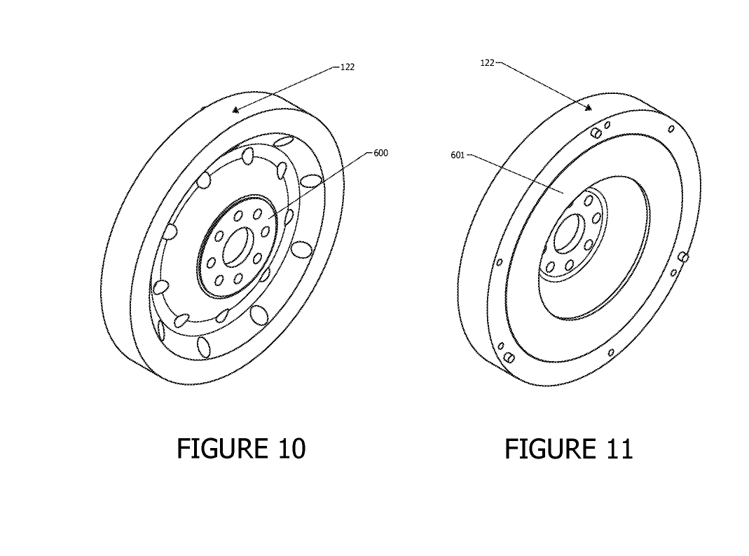

In an embodiment, the flywheel 122 has a reduced thickness of about 1 to 3 inches between the crank mating surface 600 (FIG. 10) and the flywheel friction surface 601 (FIG. 11), which is an integral part of the adaptation process. The reduced thickness of the flywheel 122 facilitates the clutch disc 123 to be arranged close enough to the transmission input shaft splines 107 in order to gain full spline engagement.

Variations of the adaptor plate 102 can be produced by machining a different bolt hole pattern into the adapter plate 102 having some, less than, or entirely different variation of the displayed bolt holes shown in FIGS. 7 and 8 in order to produce different bell housing to transmission combinations. Additional holes may be drilled into the adapter plate 102 for alignment of dowel pins on the transmission casing or on the transmission bell housing. An embodiment of utilizing the invention is in coupling a motor vehicle internal combustion engine fitted with a transmission and said transmission's bell housing to a manual shift transmission of a different manufacture, said transmission being capable of transmitting more torque than the prior existing transmission.

A circular disc having an outer diameter of about between 7 and 15 inches, and having an optimal thickness of about between 3/8 inches and 4 inch or millimeter equivalent and having a particular bolt hole pattern as shown in FIGS. 7 and 8 is placed between the bell housing 101 (FIG. 5) which is connected to the engine block, and the manual shift transmission front casing 110 (FIG. 3) aligning the bolt hole pattern of the adapter 102 (FIGS. 7 and 8) with those of the engine's bell housing 101 being coupled with bolting means.

Although the description above and accompanying drawings contains much specificity, the details provided should not be construed as limiting the scope of the embodiments, but merely as describing some of the features of the embodiments. The description and figures should not to be taken as restrictive and are understood as broad and general teachings in accordance with the present invention. While the embodiments have been described using specific terms, such description is for illustrative purposes only, and it is to be understood that modifications and variations to such embodiments, including, but not limited to, the substitutions of equivalent features and terminology may be readily apparent to those of skill in the art based upon this disclosure without departing from the spirit and scope of the invention.

What is claimed is:

1. A kit connecting an engine with a transmission, comprising:
a disc coupling a motor vehicle internal combustion engine block fitted with an automatic transmission and a bell housing to a motor vehicle manual gear shift transmission of a different manufacture;
the internal combustion engine having a flywheel and a bell housing having a bolt hole and dowel pin pattern around its circumference for coupling to a transmission housing;
said transmission bell housing comprising of a transmission assembly and a housing having a particular bolt hole and dowel pin pattern along its circumference for coupling to said engine block;
said odd shaped circular disc being generally circular and being of a particular thickness and having a bolt hole pattern consisting of said first, second, third, fourth and fifth series of bolt holes along its circumference so as to permit said engine bell housing and said transmission to fit together by bolting means, and allowing said engine and transmission to operate together as a functioning power-train assembly;
said first series of bolt holes comprising a series of recessed and counter sunk bolt holes;
said second series of bolt holes comprising a series of recessed and counter sunk bolt holes;
said third series of bolt holes comprising a series of tapped and threaded bolt holes;
said forth series of bolt holes comprising a series of tapped and threaded bolt holes;
said fifth series of bolt holes comprising a series of tapped and threaded bolt holes;
said sixth series of bolt holes comprising a series of threaded bolt holes; and
said odd shaped circular disc being disposed between the engine's bell housing and the transmission casing, said bolt hole pattern along the circumference of the odd shaped disc being aligned with the existing bolt hole patterns and dowel pins on the engine's bell housing.

2. The kit of claim 1, wherein the disc that is disposed between the bell housing of the engine and the transmission casing includes a raised machined circular step such that the disc recesses into a machined hole in the bell housing to keep the manual shift transmission and the engine concentric.

3. A kit of claim 1, for coupling a motor vehicle internal combustion engine fitted with an automatic transmission made by a first manufacturer to a manual gear shift transmission of a different manufacturer, the kit comprising:
a pilot bushing/bearing adapter for use together with a pilot bushing/bearing for keeping an input shaft pilot surface extending from a transmission/gearbox aligned with an engine crank boss;
a flywheel for attachment to the engine;
a bell-housing for attachment to the engine and to the gearbox/transmission having particular bolt hole and dowel pin patterns around its circumference, wherein the bell housing encloses the pilot bushing/bearing, the pilot bushing/bearing adapter, the flywheel, a clutch disc, and a pressure plate;
a throw-out bearing; and
an adapter plate having series of bolt holes for attaching the bell housing to the gearbox/transmission, said adapter plate having pockets for oil lubrication to pass through to a main input shaft bearing and to a counter shaft located behind an input shaft cover, and to avoid interference with components of the gearbox/transmission.

4. An adapter plate for use in coupling a motor vehicle internal combustion engine fitted with an automatic transmission made by a first manufacturer to a manual gear shift transmission of a different manufacturer having a plurality of series of bolt holes, for attaching a bell housing to the gearbox/transmission, and pockets for oil lubrication to pass through to a main input shaft bearing and to a counter shaft located behind an input shaft cover, and to avoid interference with components of the gearbox/transmission.

5. A method for coupling a motor vehicle internal combustion engine fitted with an automatic transmission made by a first manufacturer to a manual gear shift transmission of a different manufacturer, comprising:
removing a bell housing by cutting, shaving or milling the bell housing at a cut line;
removing an input shaft cover to expose a surface;
mating an adapter plate to the exposed surface so as to center the bell housing concentric to the engine; and
bolting on concentric slave cylinders into pockets in the adapter plate.
